(19) United States
(12) Patent Application Publication
(10) Pub. No.: US 2009/0107314 A1
(43) Pub. Date: Apr. 30, 2009

(54) APPARATUS FOR CUTTING TEXTURE, METHOD FOR CUTTING TEXTURE AND METHOD FOR CUTTING AND STACKING TEXTURE

(75) Inventor: Nobuo Nasu, Hiroshima (JP)

Correspondence Address: SUGHRUE MION, PLLC, 2100 PENNSYLVANIA AVENUE, N.W., SUITE 800, WASHINGTON, DC, 20037, US

(73) Assignee: NAMX CO. LTD.,, Fukuyama-shiI (JP)

(21) Appl. No.: 12/063,383

(22) PCT Filed: Aug. 8, 2006
(86) PCT No.: PCT/JP2006/315671

§ 371 Date: Feb. 8, 2008

(30) Foreign Application Priority Data
Aug. 10, 2005 (JP) 2005-232305

(51) Int. Cl. B26D 7/32; B26D 5/20; B26D 7/27

(52) U.S. Cl. 83/86; 83/403.1; 83/155

(57) ABSTRACT

[Problems] In a conventional texture cutting, little attention was paid to the accuracy of the angled or the curved texture cutting, and the accurate cutting could not be conducted. [Mean of Solving Problems] A contact point between the top edge of a lower blade 75 and a rotation blade 67 is made to intersect with a center axis C with an error range of ±3 mm. Thereby, the accuracy of the angled or curved cutting is improved. Especially, the center of the rotation blade is significantly desirable to be positioned ahead of the center axis in the traveling direction, thereby enabling the smoother cutting.

### TECHNICAL FIELD

The present invention relates to a method and an apparatus in which a procedure of cutting a texture whole cloth or of stacking a cut cloth on a specified position on a texture-stacking table can be effectively conducted for a longer period of time.

### BACKGROUND ART

The texture for a western-style cloth and a Japanese-style cloth is supplied as a very long whole cloth, which is then cut to a desired length. After the cut whole cloth is further cut into respective parts having a variety of specified shapes, the respective parts are sewed in a sewing process to provide desired clothes which are then placed on the market. In case of the dress material for a business suit, the texture per one business suit has a length slightly shorter than 3.5 meters and a width of about one meter. The texture having the dimension of this degree is difficult to handle due to the large area though the weight itself is light. Various improved methods have been proposed for automatically or semi-automatically stacking a texture which is obtained by cutting a rolled whole cloth [for example, JP-A-10(1998)-140468 (FIG. 8, and paragraphs 0020 and 0021) and JP-A-10(1998)-140469].

Since the texture 3 in contact with the conveyor belt 2 is directly cut with the cutter 1 in the above conventional texture cutting and stacking apparatus as shown in FIG. 1, the cutter 1 frequently damages the conveyor belt 2 to hardly realize the longer life of the apparatus. When the cutting starts not from the edge of the texture but from the inside of the texture, a cut for starting the cutting is hardly formed in the texture so that the desired shape can be hardly obtained by the cutting.

The cutter 1 used for the conventional texture cutting is configured by rotatably engaging the base end of a plate spring 4 with a rotating blade frame 5, and the lower end of the lower blade 6 is in point contact with the texture by means of the elasticity of the plate spring 4. When the rotating blade frame 5 is advanced (toward left-hand direction of FIG. 1), the front end of the lower blade 6 scoops up and floats the texture 3 so that the texture in contact with the rotating blade 7 is cut into the specified shape.

The lower blade 6 not only cuts the texture 3 but also damages the conveyor belt 2 by being in contact with the conveyer belt 2 in contact with the bottom surface of the texture. Further, when the cutting with the lower blade 6 starts from the inside of the texture 3, the cutting force is given to not only the texture 3 but also to the conveyor belt because the texture is in contact with the conveyor belt 2 so that the cutting force is weakened to hardly make the cut for starting the cutting in the texture 3.

Although the problems in connection with the apparatus for cutting and stacking the texture employing the conveyor have been described, these problems arise not only in the apparatus for cutting and stacking the texture. There is an apparatus in which a worker places a texture on a fixed sheet having both ends fixed, for example, around round bars, and the texture is cut with the cutter having the above configuration and converted from the fixed sheet to another place by the worker. A similar problem to that of the apparatus having the conveyor, or the damage of fixed sheet with the cutter, arises during the cutting by the apparatus.

### DISCLOSURE OF THE INVENTION

### Problems to be Solved by the Invention

In order to avert the damage of a conveyor belt due to the contact between a cutter and the conveyor belt, a process is disclosed (WO2005/005709) in which a texture is cut on a synchronizing member which is located between the conveyor belt and the texture and synchronously runs with a cutter. While this process is remarkably effective to realize the optimum cutting during the linear cutting of the cloth, a problem may arise when the texture is cut on an angled line or a curved line.

An object of the present invention is to provide a method of cutting a texture, a method of cutting and stacking a texture and an apparatus for cutting a texture which suit to angled cutting and curved cutting.

### MEANS FOR OVERCOMING THE PROBLEMS

The present invention is an apparatus for cutting a texture comprising a conveyor belt which runs with the texture to convey the texture, a cutter equipped with a rotation blade and a lower blade which is positioned above the conveyor belt, is in contact with the texture for cutting the texture, and is rotatably held on a center axis, and a synchronizing member which runs between the texture and the conveyor belt to be synchronized with a horizontal movement of the cutter, characterized in that a contact point between a top edge of the lower blade and the rotation blade intersects with the central axis with an error range of ±3 mm.

While WO2005/005709 discloses the rotation of a lower blade 6 and a rotation blade 7 around a center axis, no explicit positional relation of the center axis with respect to the lower blade 6 and the rotation blade 7 is disclosed. The accuracy of the cutting is significantly affected by the fact where the central axis in the horizontal direction with the lower blade 6 and the rotation blade 7 is positioned.

When the center axis is positioned at “A” of FIG. 2, the center axis is present ahead of the point where a texture 3 is cut in the traveling direction (left-hand direction of FIG. 2). The top plan view of the situation is shown in FIG. 3A where the texture is cut while the lower blade and the rotation blade 7 turn rightward by 90 degree after they advance straight ahead. During the straight advancing from (I) to (II), the lower blade and the rotation blade are in contact with the texture properly to perform the precise cutting thereof. However, when the lower blade and the rotation blade 7 are rotated rightward by 90 degree at (II), they turn quarter-circularly around a point “A” up to a point (III) so that the texture is cut quarter-circularly around the point “A” in accordance with the movement of the lower blade and the rotation blade 7 because the center axis is positioned ahead of the contact point between the lower blade and the rotation blade 7. Then, the lower blade and the rotation blade 7 advance upward of FIG. 3A to continue the texture cutting.

When the center axis is positioned at “B” of FIG. 2, the center axis is present backward of the point where the texture 3 is cut in the traveling direction (right-hand direction of FIG. 2). The top plan view of the situation is shown in FIG. 3B where the texture is cut while the lower blade and the rotation blade 7 turn rightward by 90 degree after they advance straight ahead. During the straight advancing from (IV) to (V), the lower blade and the rotation blade are in contact with the texture properly to perform the precise cutting thereof. However, when the lower blade and the rotation blade 7 are rotated rightward by 90 degree at (V), they turn quarter-circularly around a point “B” up to a point (VI) so that the texture is cut quarter-circularly around the point “B” in accordance with the movement of the lower blade and the rotation blade 7 because the center axis is positioned backward of the contact point between the lower blade and the rotation blade 7. Then, the lower blade and the rotation blade 7 advance upward of FIG. 3B to continue the texture cutting.

As described, when the positional relation between the center axis and the lower and rotation blades is improper, the precise texture cutting becomes impossible. Accordingly, the clothing material after the cutting cannot be finished with accurate measurement, and only unsatisfactory clothing regarding its function and appearance can be supplied. Especially, the current clothing includes various patterns, and the cuttings of the texture include angled cutting and curved cutting rather than straight cutting, and any kind of cuttings are required to be accurately conducted.

The investigation of the present inventor revealed that the accurate texture cutting could be conducted by adjusting the positional relation between the center axis and the lower and rotation blades such that these elements intersect among one another. While it is preferable that the center axis correctly intersects with the contact point of the lower blade and the rotation blade, an error range of ±3 mm at most, and of ±2 mm by ordinary can be permitted.

In the apparatus of the present invention, the rotation center of the rotation blade is significantly desirable to be positioned ahead of the center axis in the traveling direction, thereby enabling the smoother cutting.

The texture of the present invention includes a sheet made of synthetic resin and a sheet for a motor vehicle and various leathers such as bags and sofas other than the fabric-based texture.

### EFFECTS OF INVENTION

Conventionally, little attention was paid to the accuracy of the angled or the curved texture cutting.

However, the lower blade and the rotation blade precisely follow the cutting route to obtain the texture cut to a desired dimension in the present invention where the center axis which rotates the lower blade and the rotation blade substantially intersects with the contact point between both of the blades, when the center axis is rotated to cut the texture to a desired shape by the lower blade and the rotation blade.

### BRIEF DESCRIPTION OF DRAWINGS

FIG. 1 is a schematic view showing a relation between a cutter and a conveyor belt in a conventional texture cutting apparatus or cutting and stacking apparatus.

FIG. 2 is a schematic view showing a position of a rotation axis in a conventional apparatus.

FIG. 3 is a top plan view showing situations of texture cutting by using the apparatus of FIG. 2.

FIG. 4 is a perspective view showing Example 1 of a texture cutting and stacking apparatus in accordance with the present invention.

FIG. 5 is a longitudinal side-sectional view showing a cutter head of FIG. 4.

FIG. 6 is a longitudinal side-sectional view showing a situation when the cutter is rotated by 90 degree from the situation of FIG. 5.

FIG. 7 is a top plan view of the pertinent part of FIGS. 5 and 6.

FIG. 8 is a perspective view of a synchronizing member of FIG. 7.

FIGS. 9A to C are schematic views showing a cutting apparatus.

FIG. 10 is a schematic view showing a polygonal blade which can be used as the rotation blade.

FIGS. 11A and 11B are schematic views showing processes in which a texture is cut and transferred in accordance with Example 2.

FIG. 12 is a schematic view describing a texture cutting method using a fixed sheet in accordance with Example 3 of the present invention.

FIGS. 13A and 13B are schematic sectional views showing a texture pressing member in Example 4 of the present invention, and FIG. 13A shows a situation where the texture pressing member is present above the texture, and FIG. 13B shows a situation where the texture pressing member is lowered to press the texture on a projection member.

FIG. 14 is a longitudinal sectional view taken along a line A-A of FIG. 13B.

FIG. 15 is a top plan view of FIG. 14 corresponding to FIG. 8.

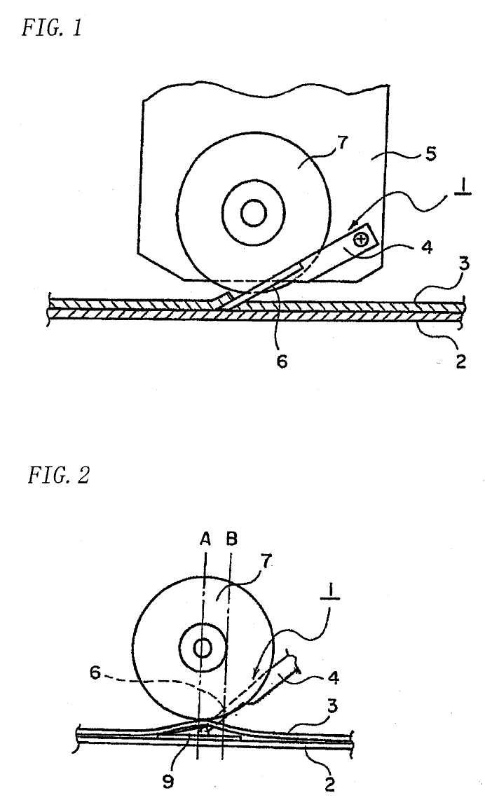

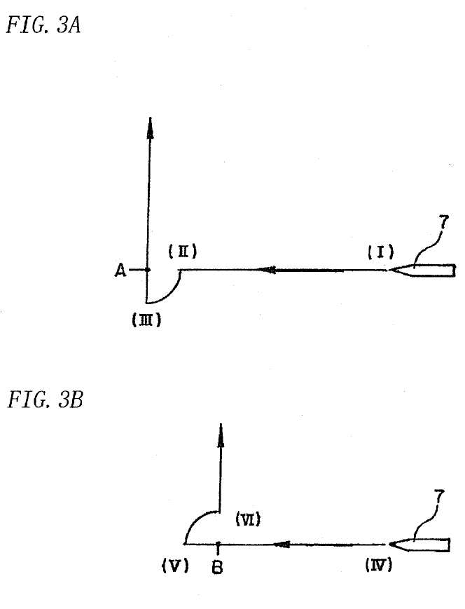

### BEST MODE FOR IMPLEMENTING THE INVENTION

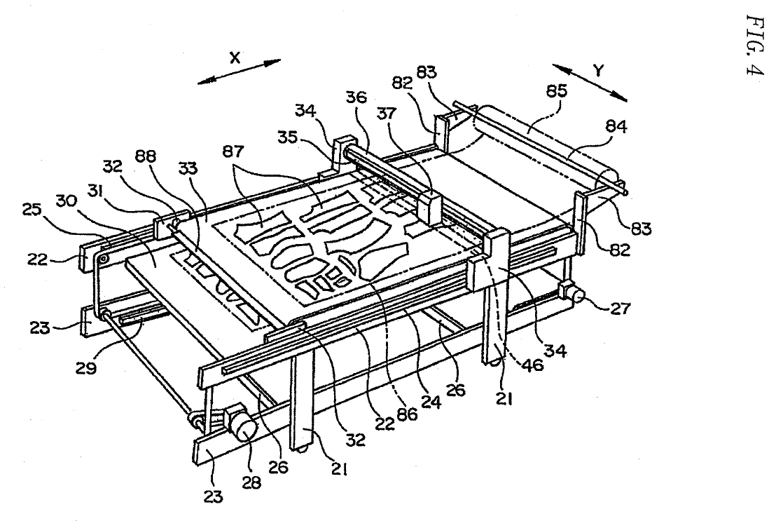

While Example 1 of a texture cutting and stacking apparatus of the present invention will be described referring to FIGS. 4 to 8, Example 1 does not restrict the present invention. As shown in FIG. 4, a numeral 21 denotes four legs positioned as each one pair in front and rear parts. Upper frames 22 and lower frames 23 span between top inner sections and between bottom inner sections, respectively, of the leg pairs of this side and of that side. A pair of guide rails 24 for carriage span along the outer surfaces of the pair of the upper frames 22, and upper guide rails 25 for a conveyor belt span along the inner surfaces thereof.

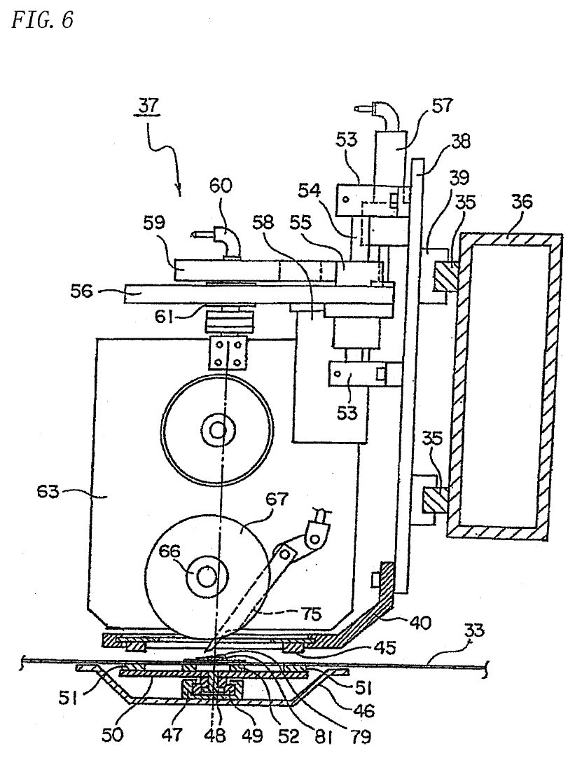

A pair of supporting bars 26 span between the pair of the lower frames 23. A conveyor belt rotating motor 27 is mounted on the right end in FIG. 6 of the lower frame 23 of this side, and a conveyor moving motor 28 is mounted on the left end. Lower guide rails 29 for the conveyor belt span on the inner surfaces of the lower frames 23. A rectangular texture-stacking table 30 spans slightly lower than the upper guide rails 25 for the conveyor belt and between the inner surfaces thereof.

Rectangular guide plates 31 are engaged in the pair of the respective upper guide rails 25 for the conveyor belt and run along the rails, and an upper end roller 32 spans between the both guide plates 31. Similarly, rectangular guide plates (not shown) run along the pair of the respective lower guide rails 29 for the conveyor belt, and a lower end roller (not shown) spans between the both guide plates. An endless conveyor belt 33 extends between the upper end roller 32 and the lower end roller through two pairs of top and bottom conveyor rollers (not shown) near the conveyor belt rotating motor 27.

Carriages 34 running along the pair of the respective guide rails 24 are mounted, and a hollow connecting member 36 having a pair guide rails 35 for a cutter head which are parallel to each other one its one side surface spans between the both carriages 34. A cutter head 37 is mounted on the pair of the guide rails 35 and can run along the hollow connecting member 36.

A frame 38 having a longitudinal length longer than that of the connecting member 36 is mounted on the cutter head 37. The frame 38 having, on its one side surface, a guide 39 having a concave section towards the guide rail is engaged with the guide rail 35 for the cutter head by using the guide 39 for running. On the other side surface of the frame 38, the base portion of an L-shaped metal attachment 40 for holding the upper synchronizing magnet having an intermediate slant is fixed with a screw 41. A round aperture 42 formed in the center of the horizontal section of the metal attachment 40 has a concave section facing sideways on its inner surface. A plate 44 for mounting an upper synchronizing magnet having, on its center, an aperture 43 which is formed by making crescent-shaped swelled parts on both ends of an angular aperture is engaged with the concave section. An upper synchronizing magnet 45 is fixed on the bottom surface of the plate 44 symmetrically on both sides of the aperture 43.

A lower guide frame 46 extending substantially parallel to the connecting member 36 between the both carriages 34 in a corresponding place lower than the upper frame 22 and having a downward swelled section on its center spans to run with the carriages. A concave slider rail 47 extends in the central swelled section of the lower guide frame 46 along its entire length. A plate-like slider 49 is engaged in the slider rail 47 to run therein while holding a lower larger diameter section of an upward-directing rotation pin 48. A plate 50 for attaching lower synchronizing magnet is fixed at the top edge of the rotation pin 48, and a pair of lower synchronizing magnets 51 are mounted in a place near to the outer edge of the attaching plate 50 and corresponding to that on which the upper synchronizing magnets exist. Further, a pair of lower sticking magnets 52 are symmetrically mounted near the central part.

The both ends of the lower guide frame 46, the lower synchronizing magnets 51 and the lower sticking magnets 52 are positioned in contact with or near to the conveyor belt 33.

A pair of mounting members 53 are placed and longitudinally separated on the other surface of the top section of the frame 38, and a guide axis 51 spans between the both mounting members 53. A bearing 55 is mounted along the guide axis 54 in a longitudinally movable manner, and a longitudinally movable frame 56 is fixed around the bearing 55 to move longitudinally with the bearing 55. The longitudinal movement of the frame 56 is conducted by a cylinder 57 for longitudinally moving the cutter, and alternately is conducted by a screw rotated by a motor.

A motor 58 for rotating the cutter is mounted on the frame 56 such that the rotation of the motor 58 is transmitted, by means of a pulley 59 for rotating the cutter, to a hollow center axis 62 supported by a center axis bearing 61, and then to an air joint 60 for moving a lower blade engaged in the center axis 62. A blade frame 63 is fixed on the opposite end of the center axis 62 of the air joint 60.

A blade aperture slightly above the lower end of the blade frame 63 is engaged with a blade axis 64, and a blade 67 having a round-blade shape is rotatably mounted around the blade axis 64 by a blade axis bearing 65 and a nut 66 for holding the blade. Although the round blade is employed as the blade, a rotation blade having a polygonal shape may be also used.

A motor 68 for rotating the blade is mounted slightly lower than the center axis 62 of the blade frame 63 so that the rotation of the motor 68 for rotating the blade is transmitted in the order of a motor axis 69, an upper gear 70, a belt 70a and a lower gear 70b to rotate the round blade 67.

An air hose 71 is connected to the center axis 61, and the other end of the air hose 71 is connected to an air cylinder 72 for moving the lower blade. A lower blade axis 73 connected to the lower end of the air cylinder 72 is communicated to a lower blade 75 held in a lower blade holder 74 by penetrating the blade frame 63. A cutter is configured by the lower blade 75 and the round blade 67.

The lower blade 75 and the round blade 67 cut the texture with contacting the bottom edge of the round blade 67 with the top edge of the lower blade. Further, the rotation axis of the center axis 61 passes through the contact point or in the range of ±3 mm from the contact point so that the cutter (lower blade 75 and round blade 67) horizontally rotates around the rotation axis.

The lower end section of the blade frame 63 is bent horizontally, and a communication pin 76 for communicating the plate 44 for mounting the upper synchronizing magnet to the blade frame 63 is engaged with the bent section.

A synchronizing member 77 shown in FIG. 6 and in contact with the conveyor belt 33 is placed on the conveyor belt 33 above the slider rail 47. The synchronizing member 77 includes a substrate 78 and a pair of projection members 79 formed on the substrate such that a trench 80 is formed between the projection members. A pair of upper sticking magnets are fixed outside the projection members 79. The projection members themselves may be used as the magnets without employing the upper sticking magnets.

A pair of belt-like members 82 are mounted facing upward in the end of the upper frame 22 near the conveyor belt rotating motor 27, and a triangular member 83 for holding a whole cloth is mounted on the rear surface of the top end of the belt-like members 82. The whole cloth 85 is held around a whole cloth bar spanning between the both whole cloth holding members 83, and the whole cloth is supplied on the conveyor belt 33 as a texture 86. Then, the texture is cut by the round blade 67 and the lower blade 75 to specified patterns, and the cut patterns are stacked on the texture-stacking table 30 by being guided by a slanted guide plate 88 mounted on the front end of the conveyor belt 33 after the backward movement of the conveyor belt 33.

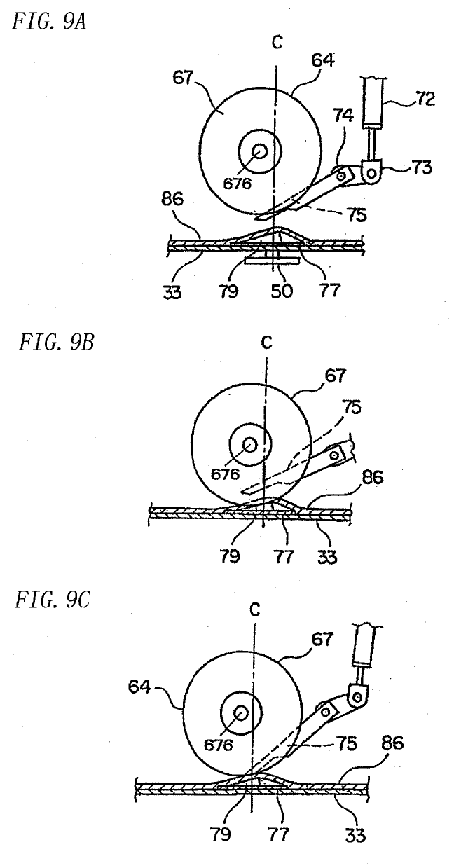

Then, the cutting in the above Example will be described referring to schematic views of FIGS. 9A to C showing the cutting procedures in addition to FIGS. 4 to 8.

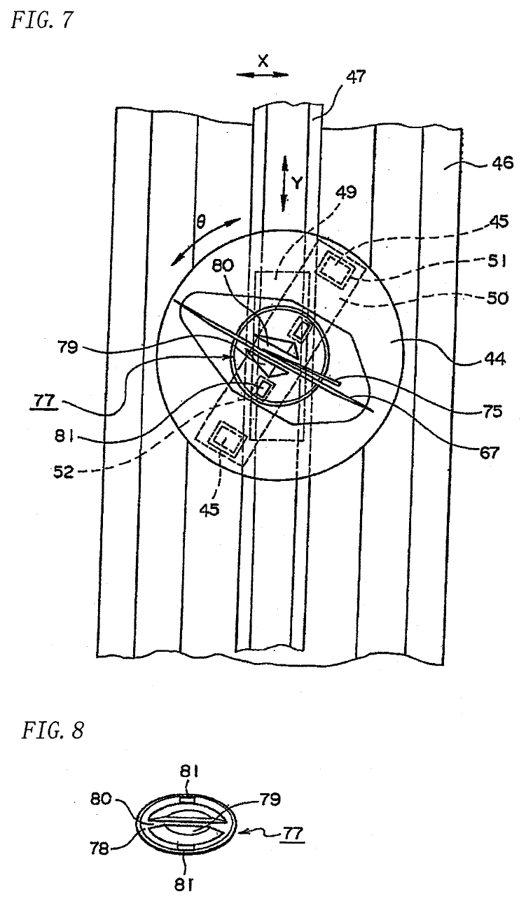

The round blade 67 and the lower blade 75 move in the width direction of the texture or the Y-direction shown in FIGS. 4 and 7 when the cutter head 37 runs along the connecting member 36, and further move in the length direction of the texture or the X-direction shown in FIGS. 4 and 7 when the carriages 34 run along the upper frames 22. The round blade 67 and the lower blade 75 can be positioned at any angle with respect to the X-direction and the Y-direction by rotating the cutter head 37 around the center axis 60 (θ direction in FIG. 7).

The synchronizing member 77 is placed on the conveyor belt 33 during the procedures of the cutting and the stacking of the texture. The upper sticking magnets 81 of the synchronizing member 77 and the lower sticking magnets 52 on the plate 50 for mounting the lower synchronizing magnets attract each other so that the synchronizing member 77 runs in synchronization with the plate 50 for mounting the lower synchronizing magnets. The lower synchronizing magnets 51 on the plate 50 and the upper synchronizing magnets 45 of the metal attachment 40 for holding the upper synchronizing magnets attract each other so that the plate 50 for mounting the lower synchronizing magnets runs in synchronization with the metal attachment 40. The positional relation in the horizontal direction among the metal attachment 40 for holding the upper synchronizing magnets, the round blade 67 and the lower blade is unchanged so that the round blade 67 and the lower blade 75 are always positioned in the trench 80 of the synchronizing member 77 or its upward space even if the cutter head 37 takes any movement when the round blade 67 and the lower blade 75 are originally designed to be positioned in the trench 80 of the synchronizing member 77 or its upward space.

The texture 86 is drawn from the whole cloth 85 to a specified position below the cutter head 37 for cutting the texture. Since the synchronizing member 77 is present on the conveyor belt 33 below the cutter head 37, the texture 86 is in contact with the top surface of the synchronizing member 77 below the cutter head 37 as shown in FIG. 9A and is not in contact with the conveyor belt 33. In this situation, the round blade 67 and the lower blade 75 are positioned above the texture 86, and the lower end of the round blade 67 is positioned lower than the front end of the lower blade 75. In this stage, the rotation center 67b of the round blade 67 is positioned ahead of the center axis C in the traveling direction.

When the round blade 67 and the lower blade 75 are then descended while the positional relation between the round blade 67 and the lower blade 75 is maintained, at first only the round blade 67 gets in contact with the texture 86 as shown in FIG. 7B. Since the trench 80 or the space is present below the texture 86 with which the round blade is contacted, a cut for starting the cutting is formed while the texture 86 maintains the downward tensile strength by the round blade 86.

Then, when the lower blade 75 are rotated downward around the connecting section between the lower blade 75 and the lower blade holder 74, the lower blade 75 together with the round blade 67 gets in contact with the texture 86 in the cut for starting the cutting. When, in the situation, the lower blade 75 and the round blade 67 are moved in the X-direction or the Y-direction by the running of the carriages 34 or the cutter head 37, respectively, or the cutter head 37 is rotated in the θ direction around the center axis 60, the texture 86 can be cut into desired shapes. Since, also in this case, the trench 80 or the space is present below the texture 86 with which the round blade is contacted, the lower blade 75 and the round blade 67 can cut only the texture 86 without being influenced by the conveyor belt 33 different from the case of FIG. 2 when the lower blade 75 and the round blade 67 get in contact with the texture for the cutting. Since, further, the texture 86 to be cut is maintained with the tensile strength between the projection members 79 on the both sides of the trench 80 of the synchronizing member 77, the lower end of the round blade 67 firstly in contact with the texture 86 can precisely form the cut for starting the cutting in the texture 86 so that the cutting can be conducted with higher accuracy.

When the cutter is run to conduct the texture cutting in this manner, the distance between the synchronizing member and the rotation blade is desirably made substantially equal to or slightly thinner than the thickness of the texture. In the latter case, the rotation blade not only cuts the texture but also draws the texture between the synchronizing member and the rotation blade so as to enable the smooth cutting.

In this Example, as shown in FIG. 9C, the top edge of the lower blade 75 is in contact with the bottom edge of the round blade 67 and the rotation axis C of the center axis intersects with the contact point, and the cutter having the lower blade 75 and the round blade 67 cuts the texture into a desired shape.

Since the contact point between the top edge of the lower blade 75 and the bottom edge of the round blade 67 acting as the cutting point of the texture is coincident with the rotation axis of the cutter in this Example, no positional disagreement is generated between the cutter and the texture when the cutter rotates so that the accurate texture cutting can be performed.

Cut patterns 87 are stacked on the texture-stacking table, which are transferred to the following sewing step, and a new texture is supplied on the conveyor belt and the cutting and the stacking are repeated.

While the round blade is used as the rotation blade in this Example, a polygonal blade may be used in place of the round blade. Generally, the polygonal blade does not refer to a blade having a geometric polygonal shape, but refer to a blade having a polygonal shape which is formed by bonding a plurality of obtuse peaks with straight lines or curved lines. Its example is shown in FIG. 10.

The polygonal blade (rotation blade) 67a shown therein includes four obtuse peaks which are bonded with four curved lines, and the contact point between the top edge of the lower blade 75 and the bottom edge of the polygonal blade 67a intersects with the rotation axis C. When the polygonal blade 67a is rotated by 45 degree, it is positioned at a place indicated with dotted lines, and the contact point between the top edge of the lower blade 75 and the bottom edge of the polygonal blade 67a moves to a rear point E not to intersect with the rotation axis. Also in this Example, the rotation center 67b of the polygonal blade 67a is positioned ahead of the center axis C in the traveling direction.

In case of the rotation blade having the different diameters such as the polygonal blade, the bottom edge thereof refers to a position having the longest diameter.

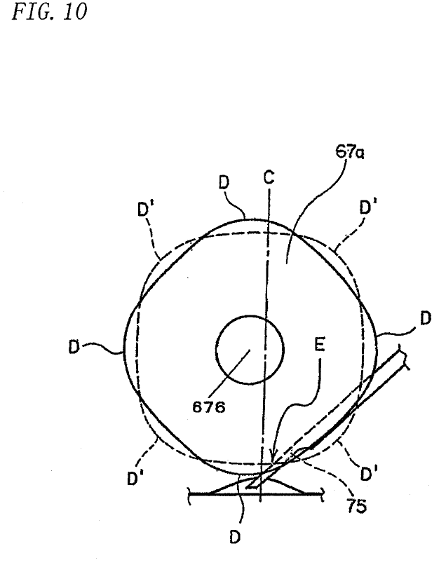

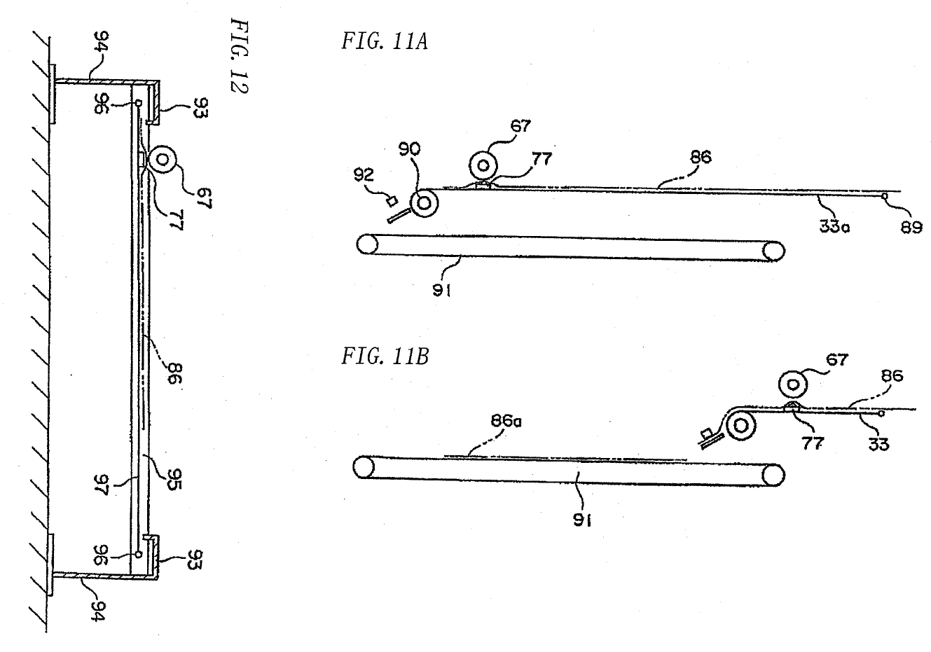

Then, a working example of a conveyor belt in the texture stacking method of the present invention (Example 2) will be described referring to FIGS. 11A and 11B. The same numerals are attached to the elements which are the same as those of Example 1, and the description is omitted.

A conveyor belt 33a in this Example has a base end fixed to an axis 89 and a top end reeled off by a reel-off roller 90. FIG. 11A show a situation where the reel-off roller has been moved in a left-hand direction to transfer the texture 86 above a receiving conveyor 91 for stacking while the texture is placed on the conveyor belt 33a. A numeral 92 denotes a texture fixing clamp.

In the situation of FIG. 11A, the texture 86 is cut by using the round blade 67 and the lower blade (not shown). Also in this situation, the positional relation among the round blade 67, the lower blade and the center axis is maintained as shown in FIGS. 9A to 9C, and the angled cutting or the curved cutting can be precisely conducted.

Then, when the reel-off roller 90 moves in a right-hand direction as shown in FIG. 11B, the conveyor belt 33a is reeled off by the reel-off roller 90 to transfer the cut texture 86a on the receiving conveyor 91 for stacking. Then, the reel-off roller 90 moves in the left-hand direction as shown in the drawing to return to the situation of FIG. 11A, and the texture cutting and the transfer of the cut texture on the receiving conveyor 91 for stacking are again repeated to perform the stacking of the cut texture.

Then, an example of a texture cutting method using a fixed sheet (Example 3) of the present invention will be described referring to FIG. 12.

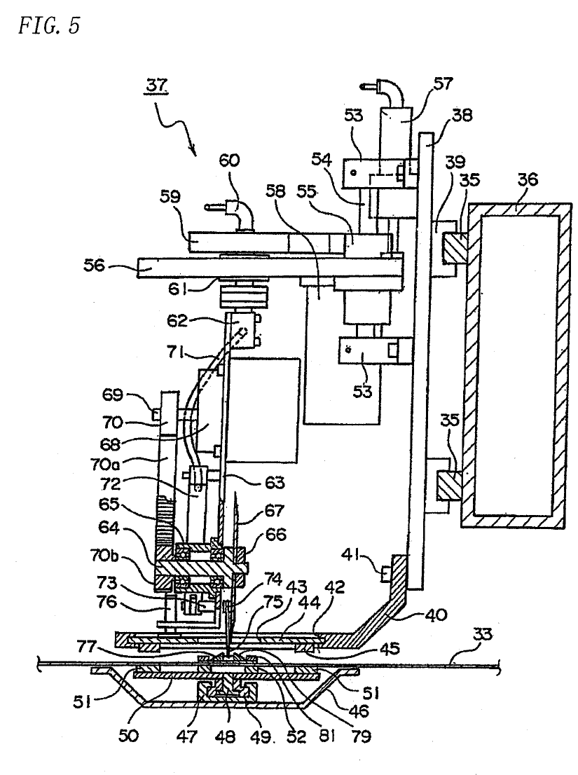

In FIG. 12, a pair of holding axes 96 are mounted near the right and left ends of a pair of anteroposterior frames 95 extending between right and left supporting platforms 94 having an adunc-shaped bended portion 93 on its top section. The fixed sheet 97 is bridged between the pair of the holding axes 96 with tensile force. The texture 86 which is prepared by cutting a whole cloth to a desired shape is manually placed on the fixed sheet 97, and the cutting is conducted using the cutting means having substantially the same configuration as that of Example 1 shown in FIGS. 5 to 9.

That is, the cutter 67 runs synchronously with the synchronizing member 77 in contact with the bottom surface of the texture 86 to cut the texture 86 while the contact point between the top edge of the lower blade and the rotation blade intersects with the central axis with an error range of ±3 mm under the situation in which the texture 86 is not in contact with the fixed sheet 97. Accordingly, the angled cutting and the curved cutting of the texture can be precisely conducted without damaging the fixed sheet 97 similar to Examples 1 and 2. Since the automatic stacking cannot be conducted in this Example, the stacking is conducted by stacking the texture cut to a desired shape manually or using a parallel established automatic stacking apparatus, if the stacking is required. The fixed sheet of FIG. 12 may be replaced with an endless belt bridged between the pair of the holding axes 96.

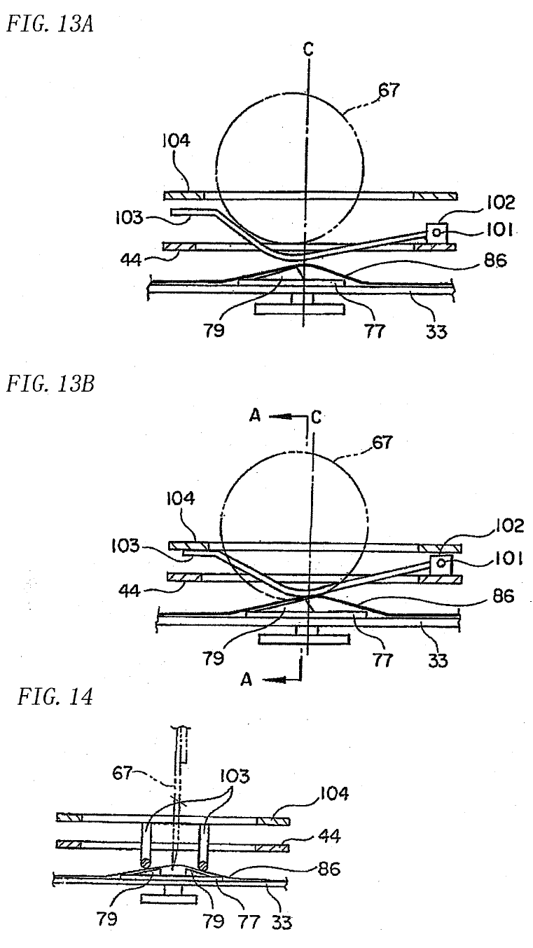

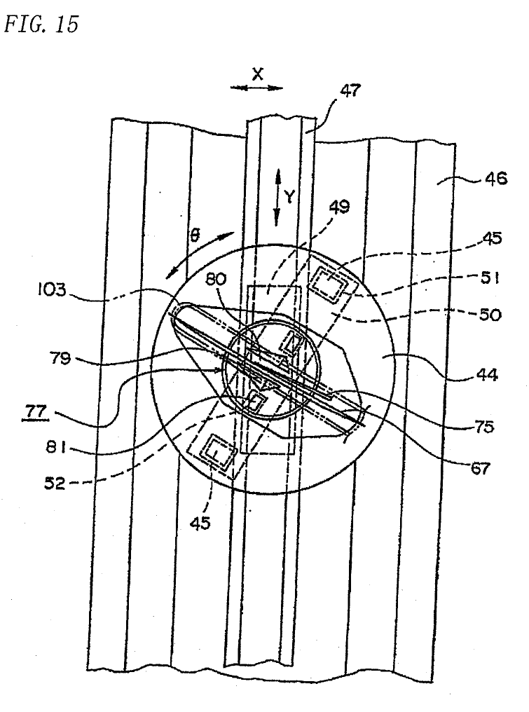

Then, an example of a texture-holding member in a method of cutting or cutting and stacking the texture in accordance with the present invention (Example 4) will be described referring to FIGS. 13 to 15.

Example 4 relates to a method of elevating the cutting accuracy by preventing the deformation of the cut surface of the texture in the direction of the concave section during the cutting of the texture by the cutter by employing the synchronizing member having the concave section, and further of smoothly conducting the cutting also when the cutting starts from the inside of the texture. Example 4 is a modification of the preceding Examples, and the description of elements the same as those of the preceding Examples is omitted by attaching the same numerals thereto.

In the present Example, a mounting device 102 having an axis 101 is fixed on the periphery of the plate 44 for mounting the upper synchronizing magnets having the opening. A metal member 103 having a curved central part for holding the texture (texture-holding member) prepared by bending a thin metal bar to a U-shape and placing its front end in the horizontal direction is supported rotatably around the axis 101. A ring 104 for holding the metal bar having substantially the same shape as that of the plate 44 for mounting the upper synchronizing magnets is mounted movable in the longitudinal direction slightly above the plate 44 (FIG. 13A). The center axis C is positioned slightly rearward (right-hand direction of FIG. 13A) of the center of the round blade 67.

When the ring 104 for holding the metal bar is descended in this situation, the ring 104 gets in contact with the front horizontal part of the metal member 103 for holding the texture so as to move the entire metal member 103 downward around the axis 101. Thereby, the curved part of the metal member 103 gets in contact with the texture 86 which is pressed toward the pair of the projection members 79 of the synchronizing member 77 so that the texture 86 between the projection members 79 is strained (FIG. 13B).

When the blade 67 in the shape of the round blade is descended in this situation, the round blade 67 is in contact with the texture 86 on the center axis C or its vicinity, and the texture is cut by the blade 67 without the deformation of the texture because the texture is strained. Also, when the cutting starts from the inside of the texture 86, the texture 86 can be accurately cut into the specified shape without providing burden to the blade. Further, depending on necessity, the cut texture can be stacked on the specified position.

Since the above embodiments are described only for examples, the present invention is not limited to the above embodiments and various modifications or alternations can be easily made therefrom by those skilled in the art without departing from the scope of the present invention.

1. An apparatus for cutting a texture comprising a conveyor belt which runs with the texture to convey the texture, a cutter equipped with a rotation blade and a lower blade which is positioned above the conveyor belt, is in contact with the texture for cutting the texture, and is rotatably held on a center axis, and a synchronizing member which runs between the texture and the conveyor belt to be synchronized with a horizontal movement of the cutter, characterized in that:
a contact point between a top edge of the lower blade and the rotation blade intersects with the central axis with an error range of ±3 mm.

2. The apparatus as claimed in claim 1, wherein a center of the rotation blade is positioned ahead of the center axis in a traveling direction.

3. The apparatus as claimed in claim 1, wherein the rotation blade is a round blade or a polygonal blade.

4. The apparatus as claimed in claim 1, wherein the synchronizing member has a concave portion on its top surface.

5. The apparatus as claimed in claim 1 further comprising a texture-holding member which is positioned opposite to the synchronizing member with respect to the texture, moves in synchronization with the cutter and presses the texture cut by the cutter on the synchronizing member.

6. An apparatus for cutting and stacking a texture comprising a texture-stacking table, a conveyor belt which runs, in a space including a top surface of the texture-stacking table, with the texture to convey the texture, a cutter equipped with a rotation blade and a lower blade which is positioned above the conveyor belt, is in contact with the texture for cutting the texture, and is rotatably held on a center axis, and a synchronizing member which runs between the texture and the conveyor belt to be synchronized with a horizontal movement of the cutter, thereby moving the texture cut by the cutter on the conveyor belt for stacking the texture on the texture-stacking table, characterized in that:
a contact point between a top edge of the lower blade and the rotation blade intersects with the central axis with an error range of ±3 mm.

7. The apparatus as claimed in claim 6, wherein a center of the rotation blade is positioned ahead of the center axis in a traveling direction.

8. An apparatus for cutting a texture comprising a fixed sheet on which the texture is placed, a cutter equipped with a rotation blade and a lower blade which is positioned above the fixed sheet, is in contact with the texture for cutting the texture, and is rotatably held on a center axis, and a synchronizing member which runs between the texture and the fixed sheet to be synchronized with a horizontal movement of the cutter, characterized in that:
a contact point between a top edge of the lower blade and the rotation blade intersects with the central axis with an error range of ±3 mm.

9. The apparatus as claimed in claim 8, wherein a center of the rotation blade is positioned ahead of the center axis in a traveling direction.
